(19) United States
(12) Patent Application Publication
(10) Pub. No.: US 2002/0088557 A1
(43) Pub. Date: Jul. 11, 2002

(54) Machine for pulling out bead wires embedded in tires

(75) Inventors: Sanzio Agostinelli, La Ricamarie (FR); Daniel Da Silva, Brioude (FR); Bruno Perrin, Saint Genest Lerpt (FR); Daniel Perrin, Saint Priest en Jarez (FR); Noel Peyron, Le Chambon Feugerolles (FR)

Correspondence Address: John Pietrangelo, Heslin Rothenberg Farley & Mesiti P.C., 5 Columbia Circle, Albany, NY, 12203, US

(73) Assignee: Sanzio AGOSTINELLI, La Ricamarie (FR)

(21) Appl. No.: 09/998,732

(22) Filed: Nov. 30, 2001

Related U.S. Application Data
(63) Continuation of application No. PCT/FR00/01500, filed on May 31, 2001.

(30) Foreign Application Priority Data
Jun. 4, 1999 (FR) FR99.07376

(51) Int. Cl. B32B 1/00

(52) U.S. Cl. 156/584

(57) ABSTRACT

The machine for tearing beads from the rims of pneumatic tires comprises a screw-jack traction element (2) whereby the rod thereof is mounted in such a way that it can be displaced in a guided linear manner in a supporting frame receiving the stem of the screw-jack in a fixed position and the free end of said rod is fitted with hooking means (3) extending through a slot (5) in a vertical bearing plate (6) of said frame. The pneumatic tire is disposed in a vertical position whereby the surface thereof rests against one of the surfaces of the plate, whereby the rim of the tire cooperates with the hooking means (3) and the slot (5) is made of two asymmetrical cross openings, defining a horizontal opening (5b) and a vertical opening (5a). The horizontal opening is symmetrically disposed on both sides of the vertical opening to enable the bead to be torn off via the horizontal opening when the rod is gradually withdrawn. The invention is characterized in that the plate (6), in combination with the profiled slot, is fitted with two parallelipipedic profiled blocks (7 and 8) which are arranged opposite each other rand which are mounted in such a way that they can slide in a guided linear manner in the opposite direction to elastic recall elements in order to be placed in a joined contact position corresponding to temporary closure of the vertical slot (5). The contact surfaces of the blocks (7 and 8) are profiled in such a way that they can be moved apart by introducing the hooking means (3) of the screw-jack (2). Said surfaces have a horizontal slot (7b, 8b) which corresponds with the branches of the horizontal opening (5b) of the slot (5) of the plate (6).

The invention relates to the technical field of the recuperation of used rubber, particularly of any type of rubbery material incorporating, within its thickness, a strengthener generally made of metal.

More specifically, the invention finds an advantageous application in the treatment of vehicle tires in general, including tires of light vehicles and heavy goods vehicles.

In order to be able to process a tire correctly, it is necessary to be able to separate the various metal parts that the tire has from the rubbery material as such. It has, in particular, proved necessary to be able to remove the bead wire or torus which the bead of the tire incorporates, on each side.

Of the various technical solutions that make it possible to pull out this bead wire, mention may be made of the teaching of U.S. Pat. No. 5,319,834. In essence, this American patent describes apparatus comprising a puller of the cylinder actuator type, the rod of which is mounted with the ability to move linearly in a support structure which holds the barrel of said cylinder actuator in a fixed position. The free end of the rod is equipped with a hook protruding through a shaped slit exhibited by a vertical bearing plate of the support structure. The tire is placed so that it bears facially, in a vertical plane, against one of the faces of said plate so that its bead collaborates with the hook. The slit consists of two openings in the shape of an asymmetric cross, delimiting a horizontal opening and a vertical opening for the passage of the hook. The horizontal opening is arranged symmetrically on either side of the vertical opening. Pulling force exerted on the rod of the cylinder actuator allows, as the latter is retracted, the corresponding bead wire to be pulled through the horizontal opening.

It would therefore seem that the vertical slit allows the passage of the hook, while the horizontal slit makes it possible, as the rod of the cylinder actuator is gradually retracted, to pull the bead wire out of the bead of the tire. However, given the specific shape of this opening, risks of the bead wire becoming jammed may arise as pulling force is exerted by the cylinder actuator to pull said bead wire out.

The invention has set itself the goal of remedying these disadvantages in a simple, safe, effective and rational way.

The problem that the invention sets out to solve is that of being able automatically to close the vertical slit that allows the passage of the hooks of the cylinder actuator rod once the tire has been caught by its heel, at the start of the pulling force exerted by the rod of the cylinder actuator, so that the bead wire can pass only through the horizontal slits as it is being pulled out.

In order to solve such a problem, the plate is equipped, in conjunction with the shaped slit, with two shaped parallelepipedal blocks arranged facing each other and mounted with the ability to slide linearly in a guided and opposed way against the action of elastic return members so as to be in a contiguous contacting position corresponding to the temporary closing of the vertical slit, the contacting faces of the blocks being shaped to allow them to part under the effect of the insertion of catching means of the cylinder actuator, said faces having a horizontal slit corresponding to the branches of the horizontal opening of the slit of the plate.

In order to solve the problem posed and allow the two sliding blocks to part to allow the passage of the catching member of the rod of the cylinder actuator, the contacting faces of the sliding blocks have, over all of their height, a slope so that in combination they delimit a convergent entrance corresponding to a chamfered shape formed at the end of the catching means of the cylinder actuator.

The blocks are mounted with the ability to slide in a window formed in the thickness of the plate so that said blocks are situated in the same vertical plane as the one defined by the bearing face that receives the tires.

The elastic members for returning the blocks to the contiguous position consist of springs housed in a counterbore formed in the thickness of said blocks, at their heel, on the opposite side to the aforementioned faces, said springs bearing against the vertical edges of the window.

Another problem that the invention sets out to solve is that of being able, in all cases, to ensure that the bead wire, which generally is made up of a number of helically wound strands, is fully pulled out. Specifically, what may happen is that some strands may not be completely pulled out and may remain secured to the tire, which may cause problems in pulling it clear, particularly in the case of an automatic installation.

To solve such a problem, the opposite face of the plate to the one that receives the tire is equipped with a cutting system secured to the support structure and capable of cutting through any remaining strands of the bead wire once the latter has been pulled out by a distance that corresponds to the end of travel of the cylinder actuator.

To solve the problem posed of cutting through any strands that remain after the entire bead wire has been pulled out, the cutting system consists of at least one articulated blade subject to a control member so as to move it against a fixed blade arranged horizontally near the horizontal opening of the slit and parallel thereto. The articulated blade is in the form of two elements arranged at an angle to delimit a V with the opening facing toward the fixed lower blade.

According to one embodiment, the member for controlling the upper blade is a cylinder actuator, the barrel of which is secured to part of the support structure, while its rod is coupled in an articulated manner to said blade.

Another problem that the invention sets out to solve is that of preventing the pulled-out bead wire from winding around the hook after it has passed through the slits.

To solve such a problem, the catching means constantly collaborates with a deflector plate mounted so that it can pivot against the action of an elastic return member so as to prevent the bead wire from winding around said catching means as the rod is gradually retracted.

The invention is set out hereinbelow in greater detail with the aid of the figures of the appended drawings in which:

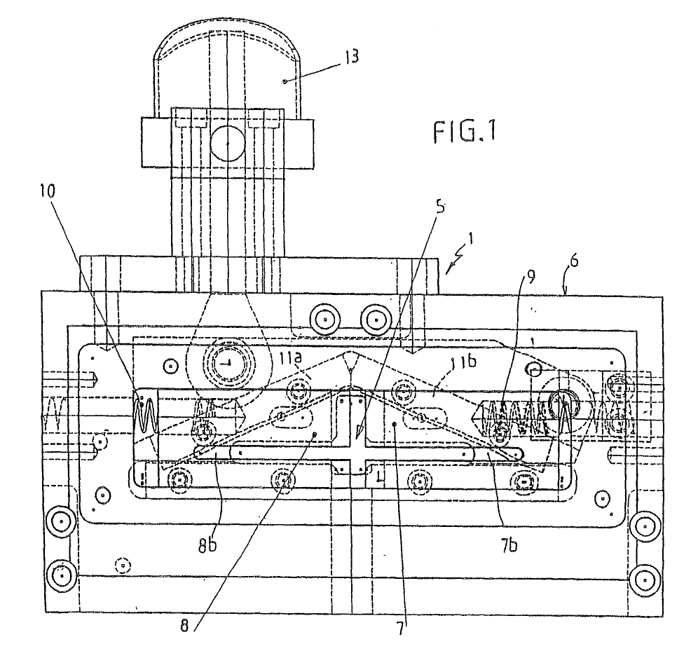

FIG. 1 is a front view of the machine;

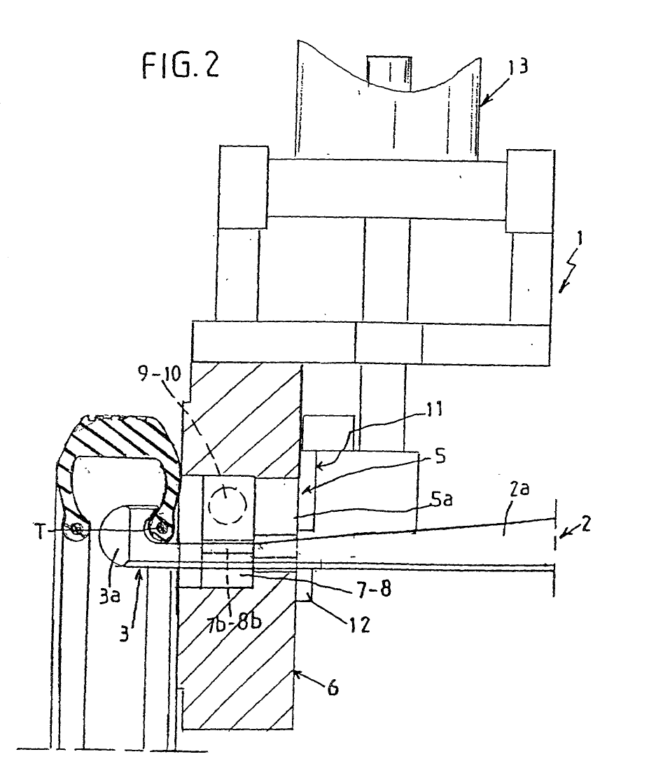

FIG. 2 is a view in cross section taken on the line 2-2 of FIG. 1;

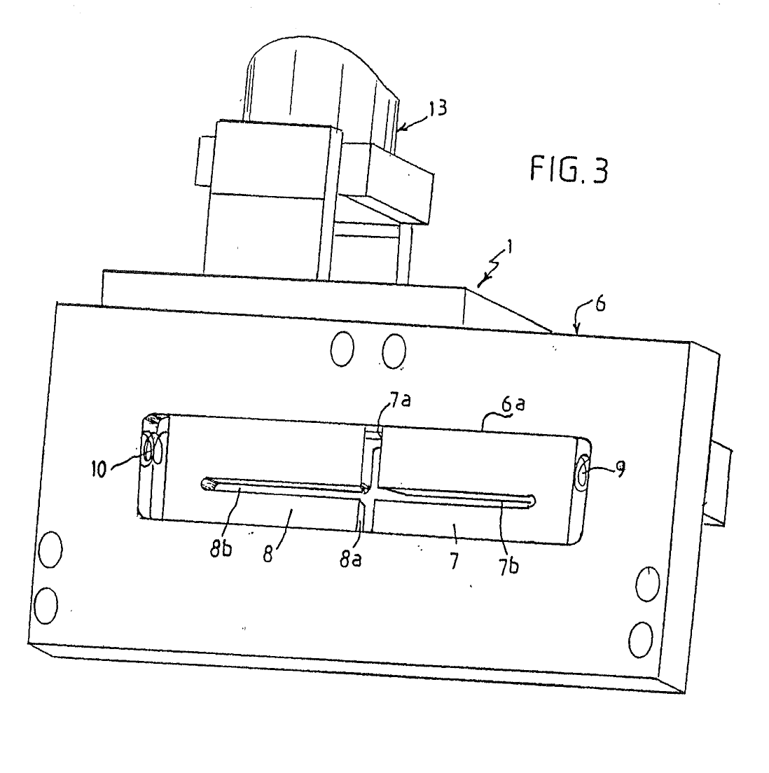

FIG. 3 is a perspective part view of the machine in the region of the bearing plate;

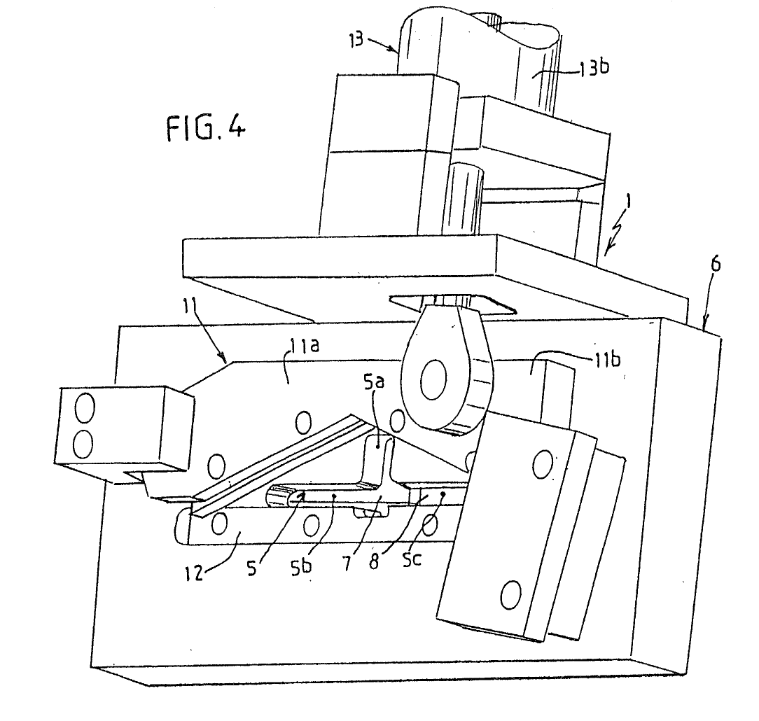

FIG. 4 is a view similar to FIG. 3, taken from the other side of the bearing plate;

FIG. 5 is a perspective view of one of the sliding blocks;

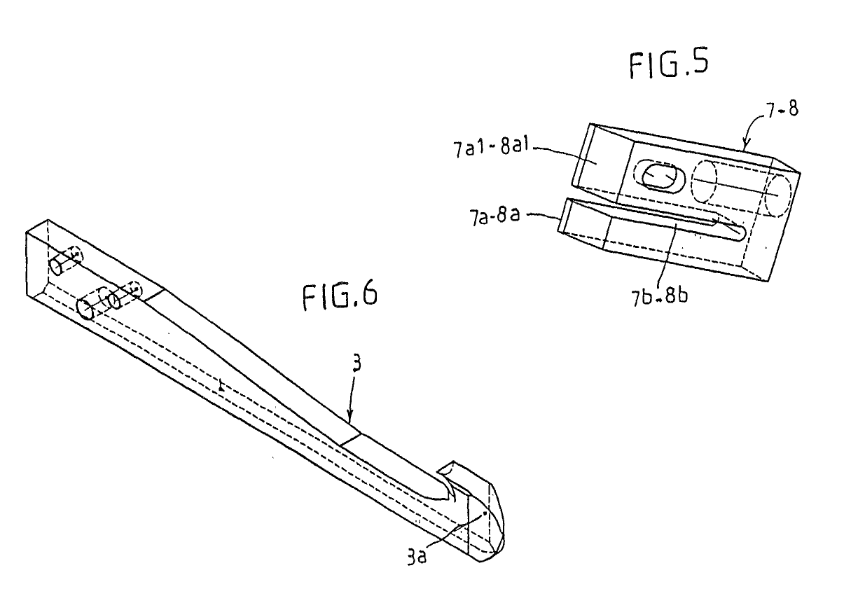

FIG. 6 is a perspective view of the catching member coupled to the rod of the pulling-out cylinder actuator;

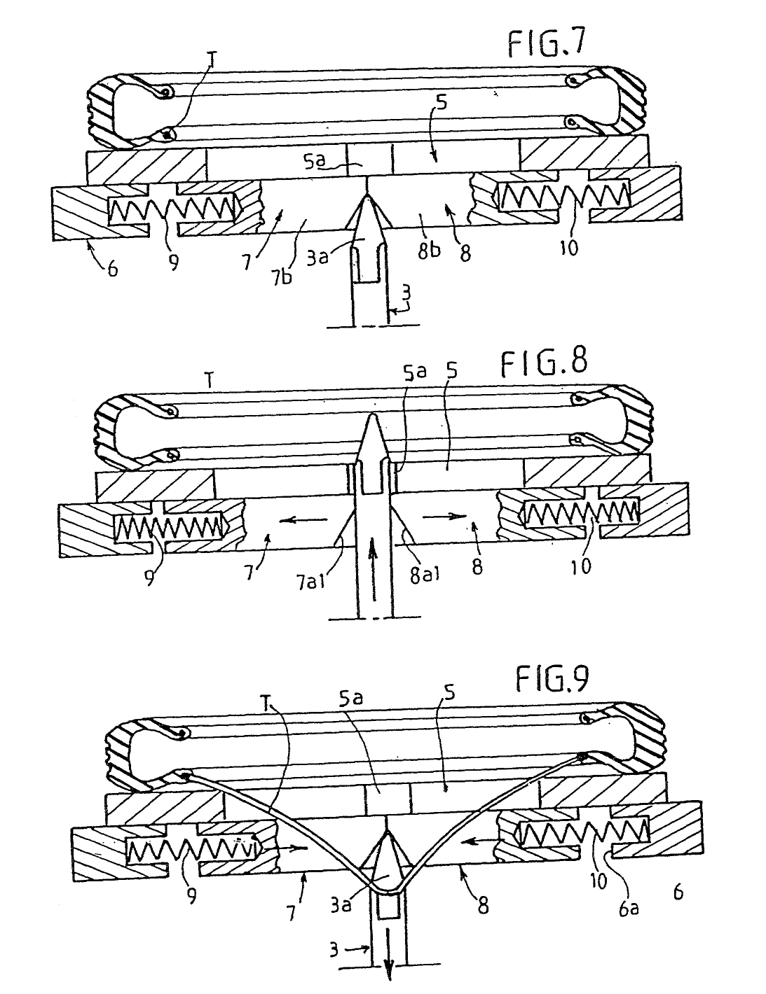

FIGS. 7, 8 and 9 are schematic plan views showing the principle of operation of the machine;

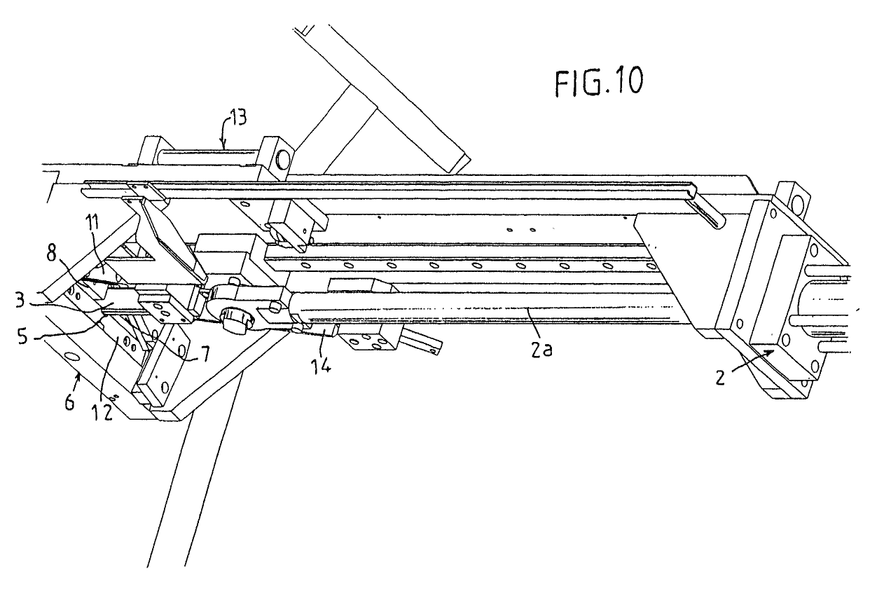

FIG. 10 is a perspective part view of part of the machine taken in a view from underneath in the region of the means controlling the movement of the hook depicted in a forward position, that is to say a position of engagement through the slits of the plate;

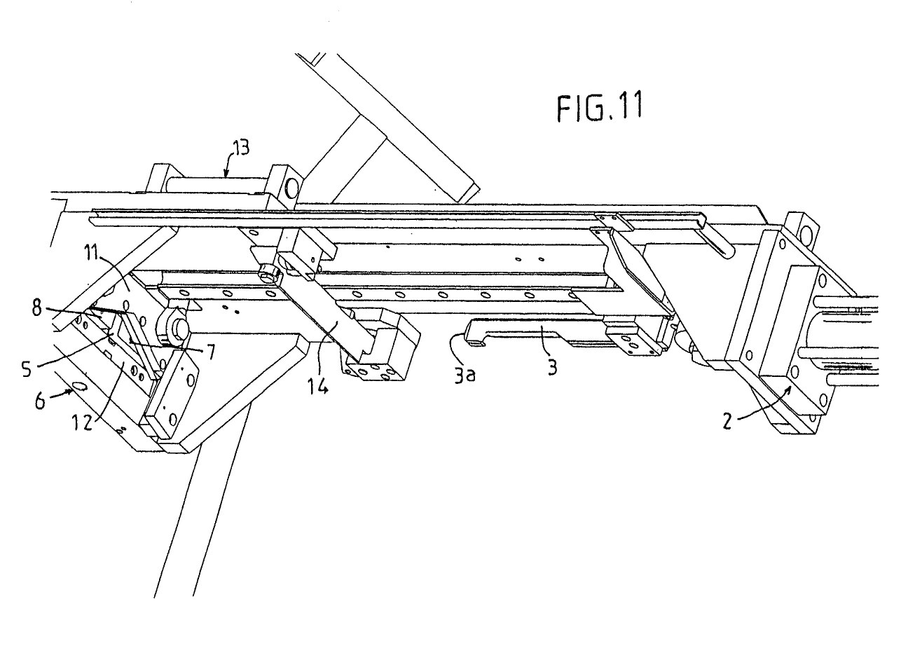

FIG. 11 is a view similar to FIG. 10 showing the retraction of the hook and the positioning of the deflector plate more or less perpendicular to the path of the hook.

Remember, for a better understanding of the remainder of the description, that the machine comprises, in a known way, a support structure (1) receiving, with the ability for guided linear movement, the rod (2a) of a control member in the form of a cylinder actuator (2), the barrel of which is secured to a fixed position of said support structure (1). The free end of the rod (2a) of the cylinder actuator (2) has a hook (3) capable of collaborating, as will be indicated in the remainder of the description, with the bead of the tire to pull out each of these bead wires (T). The assembly comprising the cylinder actuator (2) and, in particular, the hook (3) is arranged in a position of axial alignment with a slit (5) formed in the thickness of a bearing plate (6).

The plate (6) is arranged at the opposite end of the support structure (1) to the barrel (2b) of the cylinder actuator and in a vertical plane so that it is arranged at right angles to the direction of movement of said cylinder actuator. The slit (5) has the shape of an asymmetric cross delimiting a vertical opening (5a) through which the hook (3) can be engaged so that it protrudes. The vertical opening (5a) is extended laterally and at right angles to its axis of symmetry by two symmetric horizontal openings (5b and 5c) . The horizontal lateral openings are arranged level with the lower part of the vertical opening (5a).

According to a feature at the root of the invention, the cross-shaped slit (5) collaborates with two shaped parallelepipedal blocks (7 and 8) arranged facing each other and mounted with the ability to slide linearly guided and away from each other against the action of elastic return means (9 and 10) so as constantly to be in a contiguous position of contact corresponding to the closing of the vertical slit (5a). The contacting faces (7a and 8a) of the blocks (7 and 8) are shaped to allow them to part under the effect of the insertion of the catching means (3) of the cylinder actuator (2) corresponding to a pushing force by the rod of the cylinder actuator. Each of the blocks (7 and 8) has a horizontal slit (7b, 8b) corresponding to the branches of the horizontal opening of the slit (5) of the plate (6).

The vertical contacting faces (7a-8a) of each of the blocks (7 and 8) have, throughout their height, a slope (7a1-8a1) so as in combination to delimit a convergent entrance corresponding to a chamfered shape (3a) formed at the tip of the catching means (3) of the rod of the cylinder actuator.

Each of the blocks (7 and 8) is mounted with the ability to slide in a window (6a) formed in the thickness of the plate (6). Once the blocks (7 and 8) have been mounted in the window of the plate (6), these blocks lie in the same vertical plane as the one defined by the bearing face of the plate intended to receive the tire. Each of the blocks (7 and 8) has a counterbore to house the corresponding elastic return member (9 and 10) in the form of a spring, the other end of which bears against the vertical edges of the window (6). As mentioned, the springs (9 and 10) constantly return the two blocks (7 and 8) to the position in which their shaped faces (7a and 8a) are contiguous, this position corresponding to the closing of the vertical slit of the plate (6). This position in which the vertical opening of the slit (5) is closed corresponds to the extraction of the rod (2b) of the cylinder actuator.

By contrast, when a pushing force is exerted on the rod of the cylinder actuator to allow the catching of the bead wire of the tire, the shaped tip (3a) of the hooking member (2a1) under the effect of the pushing force, and the convergent entrances (7a and 8a) of the blocks (7 and 8), has the effect of parting them in two opposite directions which has the added effect of allowing the hooking member (4) to pass through the vertical opening of the shaped slit (5).

In this position in which the hooking element (3) protrudes, it is possible to catch hold of the tire. The pulling force exerted by the rod of the cylinder actuator has the effect of dragging the bead wire through the two aligned horizontal slits (7b-8b) of the blocks (7 and 8) and the two horizontal openings of the slit (5). As soon as the end of the hooking member escapes the blocks (7 and 8) as the rod is gradually retracted, these blocks are returned automatically to the position in which their faces (7a and 8a) are contiguous which corresponds to the closing of the vertical opening of the slit (5) of the plate, thus forcing the bead wire to pass only through the horizontal openings in the blocks and in the plate so as to avoid any possible phenomenon of jamming. Reference can be made to the schematic figures of the drawings which illustrate such an operation.

According to another important feature of the invention, the opposite face of the plate (6) to the one that receives the tire, that is to say the one from which the window accommodating the sliding blocks (7 and 8) is formed, is equipped with a cutting system secured to the support structure. This cutting system is designed to cut off any remaining strands of bead wire once the latter has been pulled out to an extent that corresponds to the end of travel of the cylinder actuator.

To this end, the cutting system consists of at least one articulated blade (11) subject to a control member for moving it against a fixed blade (12) arranged horizontally near the horizontal opening of the slit of the plate (6). The fixed mating cutting blade (12) is located parallel to the horizontal opening of the slit (5). The articulated blade (11) is in two elements (11a and 11b) arranged at an angle to delimit a V with the opening facing toward the fixed lower blade (12). The blade (11) is, for example, coupled, in an articulated manner, to the rod (13a) of the cylinder actuator (13) that constitutes the control member, and the barrel (13b) of which is secured to part of the support structure (1) of the machine. When the pulling-out cylinder actuator has completed its stroke, the cylinder actuator (13) is actuated to control the cutting system and, accordingly, cut through any constituent strands of the bead wire (T) which might not have been completely pulled out.

Another problem that the invention proposes to solve is that of preventing the bead wire from winding itself inadvertently around the hook (3) as the control rod (2) is gradually withdrawn. To this end, part of the support structure of the machine has a deflector plate (14) mounted to pivot against the effect of an elastic return member (not depicted) so as to prevent the bead wire (T) from becoming wound around the hook (3). When the rod (2a) of the cylinder actuator (2) is retracted, that is to say when the hook (3) is in the retracted position, the deflector plate (14) is oriented more or less at right angles to the direction of travel of the hook (3), thus being positioned between the rear face of the plate (6) and the front end (3a) of the hook (3) (FIG. 11).

The result of this is that, under a pushing force exerted on the rod (2a) of the cylinder actuator (2) to hook onto the bead wire of the tire, the shaped part (3a) of the hooking member (3), under the effect of the pushing force, causes the deflector plate (14) to pivot through an angle and therefore automatically position itself against the hook (3).

Quite obviously, the position in space of the deflector plate (14) is determined according to the plate (6) and according to the heightwise position of the hook (3).

As mentioned, these arrangements prevent the pulled-out bead wire from winding around the hook (3).

Note that this machine finds a particularly advantageous application in equipping an installation of the kind defined in patent application FR 98/13909 of which the applicants are also the proprietors. To this end, the station for pulling out bead wires comprises two machines according to the characteristics defined and illustrated, and arranged facing each other so as to process and simultaneously pull out both sets of bead wires from the bead of the tire.

The advantages are clearly apparent from the description.

1. A machine for pulling out the bead wires that are present in the beads of tires, comprising a puller of the cylinder actuator type (2), the rod of which is mounted with the ability to move linearly guided in a support structure which holds the barrel of said cylinder actuator in a fixed position, the free end of said rod being equipped with a catching means (3) protruding through a slit (5) exhibited by a vertical bearing plate (6) of the support structure, the tire being arranged vertically bearing facially against one of the faces of said plate so that by its bead it collaborates with the catching means (3), said slit (5) consisting of two openings in the shape of an asymmetric cross, delimiting a horizontal opening (5b) and a vertical opening (5a), the horizontal opening being arranged symmetrically on either side of the vertical opening so as to allow, as the rod is retracted, the bead wire to be pulled through the horizontal opening, characterized in that:
the plate (6) is equipped, in conjunction with the shaped slit (5), with two shaped parallelepipedal blocks (7 and 8) arranged facing each other and mounted with the ability to slide linearly in a guided and opposed way against the action of elastic return members so as to be in a contiguous contacting position corresponds to the temporary closing of the vertical slit (5), the contacting faces of the blocks (7 and 8) being shaped to allow them to part under the effect of the insertion of the catching means (3) of the cylinder actuator (2), said faces having a horizontal slit (7b, 8b) corresponding to the branches of the horizontal opening (5b) of the slit (5) of the plate (6).

2. The machine as claimed in claim 1, characterized in that the contacting faces (7a, 8a) of the sliding blocks (7 and 8) have, over all of their height, a slope (7a1-8a1) so that in combination they delimit a convergent entrance corresponding to a chamfered shape (3a) formed at the end of the catching means (3) of the cylinder actuator (2).

3. The machine as claimed in claim 1, characterized in that the blocks (7 and 8) are mounted with the ability to slide in a window (6a) formed in the thickness of the plate (6) so that said blocks (7 and 8) are situated in the same vertical plane as the one defined by the bearing face that receives the tires.

4. The machine as claimed in either one of claims 1 and 3, characterized in that the elastic members for returning the blocks (7 and 8) to the contiguous position consist of springs (9 and 10) housed in a counterbore formed in the thickness of said blocks at their heel, on the opposite side to the aforementioned faces, said springs bearing against the vertical edges of the window (6a).

5. The machine as claimed in claim 1, characterized in that the opposite face of the plate (6) to the one that receives the tire is equipped with a cutting system secured to the support structure and capable of cutting through any remaining strands of the bead wire once the latter has been pulled out by a distance that corresponds to the end of travel of the cylinder actuator.

6. The machine as claimed in claim 5, characterized in that the cutting system consists of at least one articulated blade (11) subject to a control member (13) so as to move it against a fixed blade (12) arranged horizontally near the horizontal opening (5b) of the slit and parallel thereto.

7. The machine as claimed in claim 6, characterized in that the articulated blade (11) is in the form of two elements arranged at an angle to delimit a V with the opening facing toward the fixed lower blade (12).

8. The machine as claimed in claim 6, characterized in that the member (13) for controlling the upper blade (11) is a cylinder actuator, the barrel of which is secured to part of the support structure (1), while its rod (13a) is coupled in an articulated manner to said blade (11).

9. The machine as claimed in claim 1, characterized in that the catching means (3) constantly collaborates with a deflector plate (14) mounted so that it can pivot against the action of an elastic return member so as to prevent the bead wire from winding around said catching means as the rod (2) is gradually retracted.

10. The machine as claimed in claim 9, characterized in that, when the catching means (3) is in the retracted position, the plate (14) is oriented roughly at right angles to the direction of travel of said catching means (3) whose movement, in the direction of the plate (6), causes said plate to pivot into the position of bearing on the catching means.
